(19) United States
(12) Patent Application Publication
(10) Pub. No.: US 2009/0178334 A1
(43) Pub. Date: Jul. 16, 2009

(54) Seed mat system

(76) Inventor: Constance J. Henderson, Oceanside, CA (US)

Correspondence Address: THE NATH LAW GROUP, 112 South West Street, Alexandria, VA, 22314, US

(21) Appl. No.: 12/285,849

(22) Filed: Oct. 15, 2008

Related U.S. Application Data
(60) Provisional application No. 60/960,800, filed on Oct. 15, 2007.

(51) Int. Cl. A01C 1/04

(52) U.S. Cl. 47/56

(57) ABSTRACT

A seed mat structure enables seeds to germinate relatively quickly, have fast maturation rates and be hardier. Seeds and at least one soil amendment component are positioned with a first layer on a second layer. The first layer comprises a reticulate fabric including a grid with openings allowing passage of water. Fibers extending into grid openings facilitate adherence of the seeds within the openings and retention in the grid. The second layer is hygroscopic, and could, for example, comprise absorbent paper towel or heavy tissue. Both layers of the mat are preferably biodegradable. The mat may have zones, each zone being dedicated to a different type of seed or seeds. In a further embodiment, a planting system is provided in which a set of soil amendments external to the seed mat is provided including selected components proportioned to the size of the seed mat and optimized for the seed mat components.

### CROSS REFERENCE TO RELATED APPLICATIONS

The present application claims priority of U.S. Provisional Patent Application Ser. No. 60/960,800, filed Oct. 15, 2007, which is incorporated by reference herein in its entirety.

### BACKGROUND OF THE INVENTION

1. Field of the Invention

The present subject matter relates generally to seed mats and planting systems incorporating seed mats, including seed mats which may be comprised of vegetables, lettuces, and/or flowers.

2. Related Art

A seed mat comprises, in a typical form, a plurality of sheets arranged in layers. Seeds are placed in the layers in a manner such that they can germinate and grow. Layers of compost or other additional materials are provided for allowing a plant to grow upwardly from the mat and roots to grow downwardly from the mat. Layers may include such materials as fertilizers, hydrogels, mulch and other growing media. Commonly, mats are folded for shipment or storage. For planting, the mats are unfolded and placed on prepared soil. A thin layer, e.g., ¼ inch, of soil is used to cover the mat. For optimum germination and growing the soil needs to be prepared with amendments prior to planting.

A number of prior art structures comprising seed mats have been provided with various means for supporting seeds and amendments.

U.S. Pat. No. 5,417,010 discloses a lightweight seeding sheet consisting of a flexible reticulate sheet permeable by blades of vegetative crops. A bonding agent is applied to one side of the reticulate layer. The bonding agent holds a uniform distribution of particles of fertilizer, seeds and other plant growth additives. Prior to deployment, the seeding sheet is rolled up for storage. A parting layer is disposed on the reticulate sheet to keep the reticulate sheet from sticking to itself when it is rolled up. Examples of materials for the parting layer include a water dispersible tissue paper, a water-soluble wax coating, a water-soluble polymer coating or a layer of sprinkled organic material or mineral particles. While the seeding sheet comprises two layers, the parting layer does not comprise structure supporting the seeds and interacting with the reticulate layer in promoting growth of the seeds.

U.S. Patent Application Publication No. 20050028441 discloses an artificial seedbed in which seeds are displaced along the length of a tape. A base layer is a biodegradable product having a porosity and density that permits a root to penetrate the base layer. An intermediate later has seeds, and a cover layer cooperates with the base layer to form an envelope about the intermediate layer. The base layer and the cover later preferably include natural fibers such as jute, palm fiber and wood fiber. The central layer includes seeds and fertilizer and may further include nutrients. The seeds are not secured to a reticulate layer.

U.S. Patent Application Publication No. 20030000140 discloses a seed tape having germinating units placed along its length. The seed tape has upper and lower paper layers, and seeds and attitudes are placed between the layers. There is no reticulate layer.

U.S. Patent Application Publication No. 20050183329 discloses biodegradable extruded netting. Various biodegradable materials are disclosed which may be made into a net in a simplified manufacturing process rather than by weaving.

U.S. Patent Application Publication No. 20050262762 discloses a method of sticking plant seeds on a seed fixing film mat. The disclosure is particularly directed to handling seeds for edible plants. The mat may be either biodegradable or insoluble. The plant seeds are each enclosed within a gel enclosure. A layer of additives is placed over the first gel enclosure, and a second gel layer is placed over the additive. Seeds placed on the mat are heated so that the outer gel layer adheres to the mat.

U.S. Patent Application Publication No. 20050028440 discloses a seed mat in which seeds are placed on a lower layer. A thin-film layer may be placed over the seeds and the lower layer. Various ways of sandwiching seeds between upper and lower film components are disclosed.

The prior art does not provide a comprehensively interactive structure as contemplated by the present subject matter.

### SUMMARY OF THE INVENTION

Embodiments of the present invention are directed to seed mats, methods of manufacture and systems for planting seed mats. Structure is provided which enables seeds to germinate relatively quickly and have fast maturation rates. The structure provides an environment in which seeds are in effect hardier than they would be if they were simply planted in soil. Use of the present seed mat can promote a novice gardener's sense of success. The seed mat has first and second layers. Seeds and at least one soil amendment component are positioned with the first layer on the second layer. The positioning may include placement between a first and a second layer. The first layer comprises a reticulate fabric, e.g., burlap or woven jute, including a grid with openings allowing passage of water. Fibers extend out of the crossed members of the grid into openings. Presence of the fibers facilitates adherence of the seeds within the openings and retention in the grid. The second layer is hygroscopic, and could, for example, comprise absorbent paper towel or heavy tissue. Both layers of the mat are preferably biodegradable. The mat may have zones, each zone being dedicated to a different type of seed or seeds in order to provide a preselected arrangement of plants.

The seed mat is deployed by placing it in a shallow recess in prepared soil and covering it with planting composition. In a further embodiment, a system is provided in which a set of soil amendments is provided including selected components proportioned to the size of the seed mat and optimized for the seed mat components. A user need neither measure nor calculate amounts of amendments to be used.

### BRIEF DESCRIPTION OF THE DRAWINGS

Embodiments of the invention are more particularly described with reference to the following drawings taken in connection with the following description.

FIG. 1 is a perspective view of a seed mat constructed in accordance with embodiments of the present invention disposed in an inverted position with respect to its disposition when deployed;

FIG. 2 is an exploded view of FIG. 1 illustrating layers and components included therein;

FIG. 3 is a partial detailed cross-sectional view of the embodiment of FIG. 1;

FIG. 4 is an illustration of a reticulate layer suitable for inclusion in the embodiment of FIG. 1;

FIG. 5, consisting of FIGS. 5a-e, is an illustration of a number of a variety of seeds;

FIG. 6 is an illustration of an alternative form of a reticulate layer;

FIG. 7 is a perspective view of one form reticulate layer having adhesives and seeds disposed thereon;

FIG. 8 is a perspective view of another form of reticulate layer having adhesives and seeds disposed thereon;

FIG. 9 is a cross-sectional view of a cover layer assembled to a reticulate layer;

FIG. 10 is a cross-sectional view of a first stage installation of a seed mat in soil;

FIG. 11 is a further cross-sectional view of installation of a seed mat in soil; and

FIG. 12 is an illustration of a planting system comprising a seed mat and soil amendments.

### DETAILED DESCRIPTION

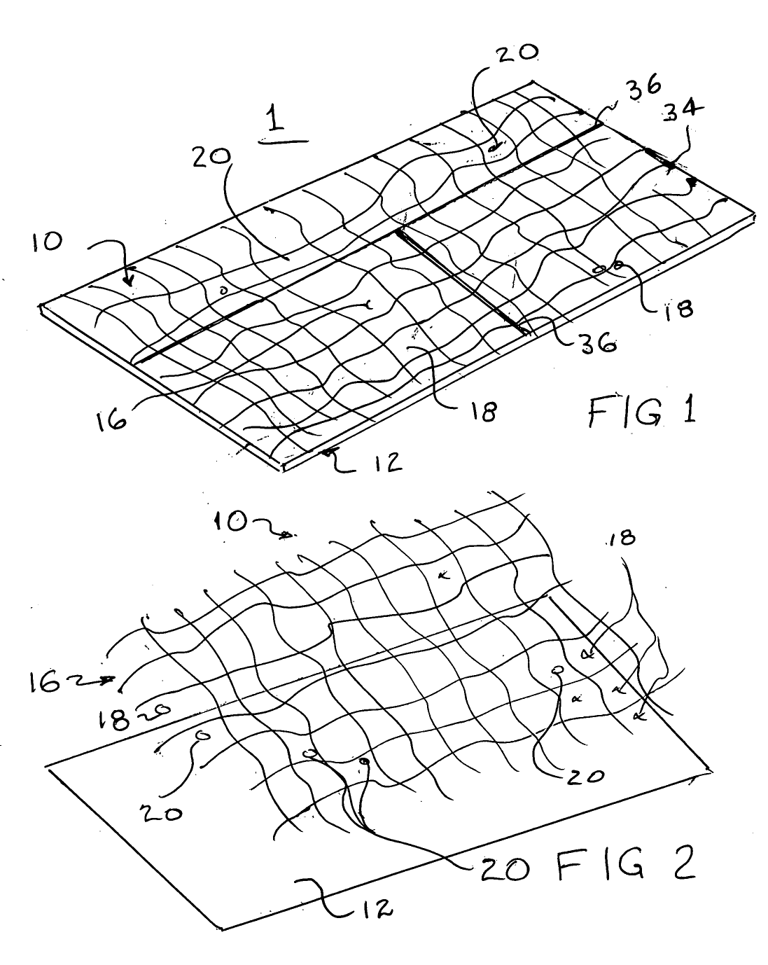

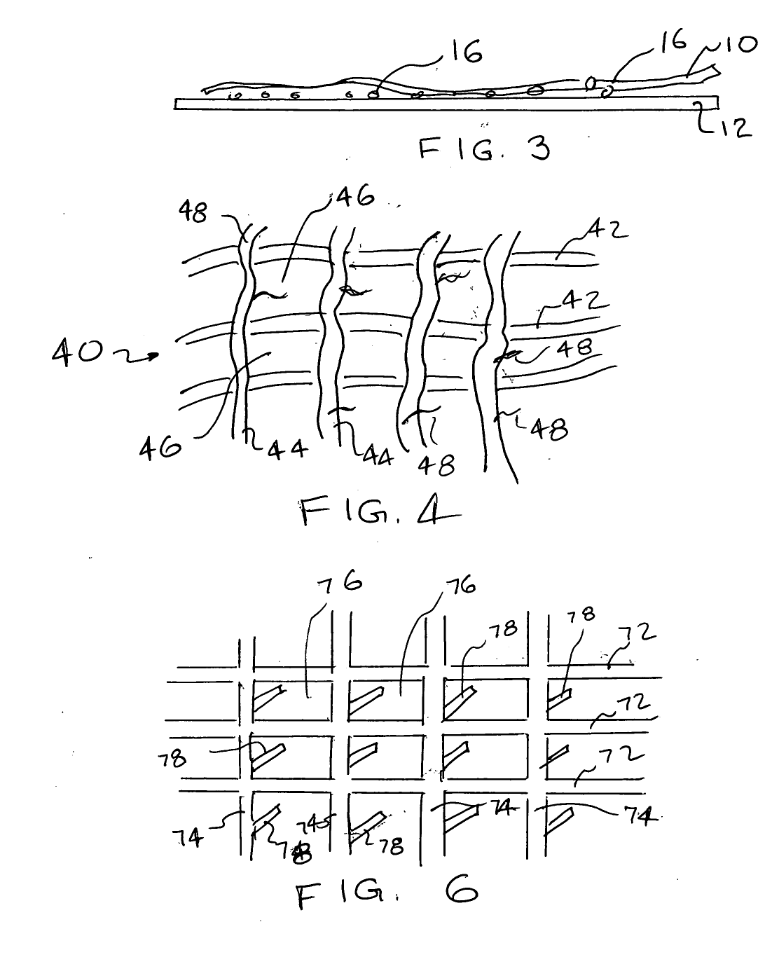

Embodiments of the present invention provide a structure which enables seeds to germinate relatively quickly, have fast maturation rates and grow to be hardier. This structure will enhance a user's sense of success in establishing a garden plot. A first embodiment of the present invention is described with respect to FIG. 1, FIG. 2 and FIG. 3. FIG. 1 is a perspective view of a seed mat 1. FIG. 2 is an exploded view of FIG. 1 illustrating layers and components included therein. FIG. 3 is a partial detailed cross-sectional view of the embodiment of FIG. 1.

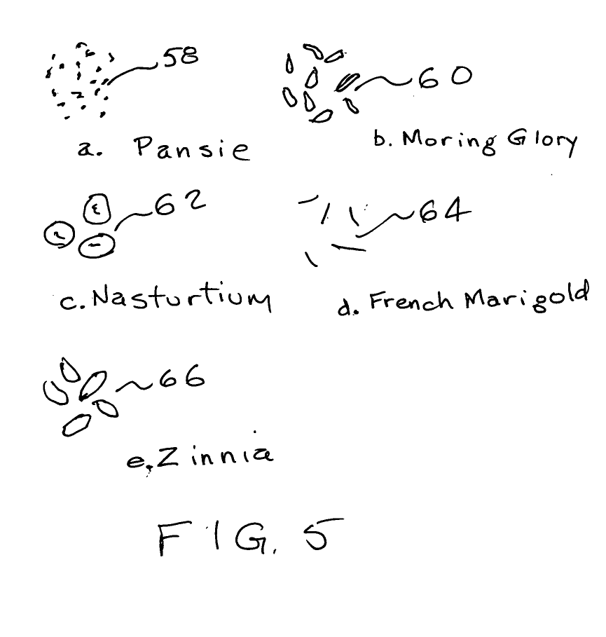

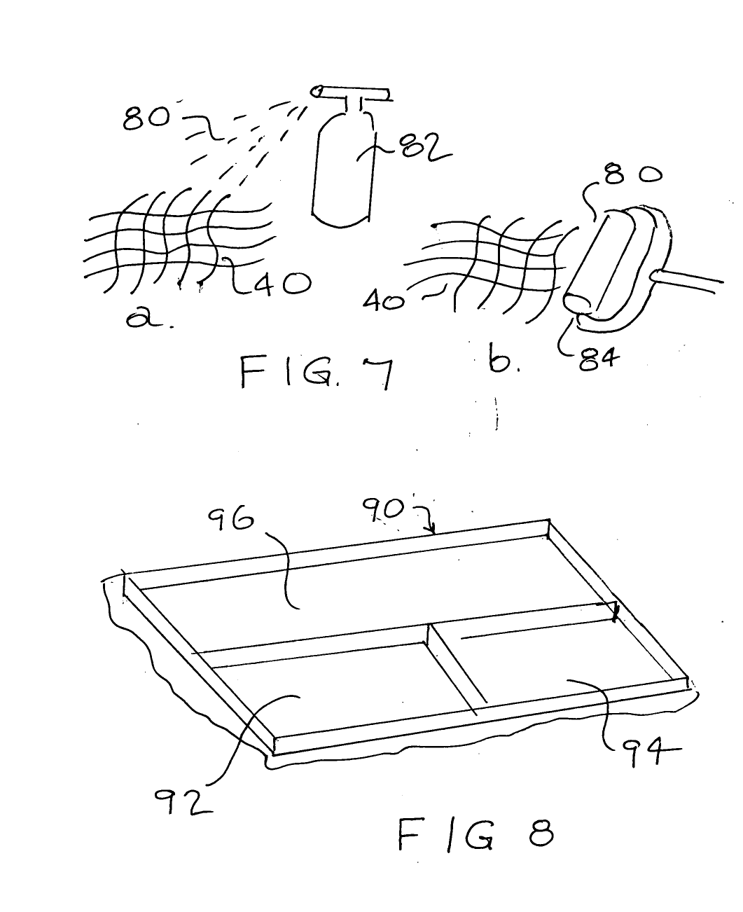

Referring now to FIGS. 1-3, the seed mat 1 has first layer which is a reticulate layer 10. A second layer comprises a hygroscopic layer 12. Both the layers 10 and 12 are preferably biodegradable. The layers 10 and 12 support a growth mixture 16. The growth mixture 16 comprises seeds 18 and at least one soil amendment component 20. The seeds 18 may be of a single species, or may be of a plurality of species, for example seeds 58-66 further described below with respect to FIG. 5. The seed mat 1 may have zones, each zone being dedicated to a different type of seed or seeds in order to provide a preselected arrangement of plants. An adhesive 80 (FIG. 7) secures the growth mixture 16 to the seed mat 1.

The soil amendment components 20 may take many forms. One convenient form is a pellet. Capsules or other forms could be provided. If desired, each type of soil amendment component 20 may be provided with a distinguishing color and a distinguishing shape or form. Materials included in the soil amendment components 20 may comprise time-release fertilizer, hydrating components and other plant growth supplements. In some embodiments, for example those including flowers that do not respond well, fertilizer will not be included. However, fertilizer may be included in other embodiments. Other embodiments may include time-release fertilizer pellets that last up to three months.

The seed mat 1, in a further form has zones, each zone being dedicated to a different type of seed or combination of seeds. The zones may be located with respect to each other to provide a desired effect. For example, taller flowers may be placed in a zone behind a zone containing shorter flowers. In the present illustration, as seen in FIG. 1, first, second, and third zones 30, 32 and 34 are provided. Border lines 36 may be provided to clearly mark zone boundaries.

FIG. 4 is a plan view of one form of reticulate layer 10. The reticulate layer 10 comprises a grid 40 defined by transverse members 42 and longitudinal members 44. The terms transverse and longitudinal are arbitrary. They are used here to denote that the transverse members 42 and longitudinal members 44 cross each other. Apertures 46 are defined by portions of adjacent transverse members 42 that are between portions of the adjacent transverse members 44. The transverse and longitudinal members 42 and 44 need not necessarily be perpendicular to each other. Indeed, many materials of which the reticulate layer 10 may be composed will have transverse and longitudinal members 42 and 44 which are not straight. It is preferred, in one form, to have transverse and longitudinal members 42 and 44 that are substantially perpendicular in order to maximize area of the apertures 46 for given lateral dimensions at the perimeter of each aperture 46.

In accordance with one aspect of the embodiment of the present invention, fiber projections 48 are provided projecting from transverse members 42 and longitudinal members 44. Suitable materials for the grid 40 include natural fibers such as burlap or woven jute. Burlap is a coarse fiber. Fiber projections 48 to some degree will inherently be present. Additionally, the transverse and longitudinal members 42 and 44 may be abraded to produce additional fiber projections 48. The fibers 48 extend into the apertures 46. However, fibers 48 need not be provided in every one of the apertures 46. The fibers 48 each provide a support for positioning a particle of the growth mixture 16 in one of the apertures 46. Presence of the fibers 48 facilitates adherence of the seeds 18 (not shown in FIG. 4) within the apertures 46 and helps prevent washing seeds out of the seed mat 1. This structure has the characteristic that a certain percentage of seeds will be positioned completely or primarily within the boundaries of an aperture 46. Water flow over and across seeds in apertures 46 is maximized.

The provision of the reticulate layer 10 enhances the ability to thin sprouts, i.e., remove some of the plants after they have sprouted. Since the sprouts are pulled from the open grid work of the reticulate layer 10, the risk is minimized of pulling up entire sections of plants. This is a concern in situations in which a continuous layer is in a seed mat above the seeds.

The hygroscopic layer 12 could, for example, comprise absorbent paper towel or heavy tissue. The hygroscopic layer 12 resting on soil aids in water retention, keeping more moisture next to the seeds 18 where it is needed. The positioning of the hygroscopic layer 12 is contrasted to certain prior art embodiments in which a continuous layer is placed above seeds and absorbs water before the water reaches the seeds. After the seed mat 1 is planted, water will break down the fibrous material in the second layer so that roots emerging from the seeds 18 grow downwardly through the hygroscopic layer 12 into surrounding soil.

FIG. 5, consisting of FIGS. 5a-5e, is an illustration of a number of a variety of seeds 58-66. The seed mat 1 may be used to provide an array of various species of flowers. Many different flowers have widely divergent shapes of seeds. Embodiments of the present invention seek to provide a way of accommodating various types of seeds. Whereas a seed mat providing only grass seed will need to accommodate only one seed geometry, a seed mat 1 with flower patterns will need to accommodate many different sorts of seeds. FIG. 5a illustrates pansy seeds 58, which are small and resemble grass seeds. FIG. 5b illustrates morning glory seeds 60, which have some geometrical similarities to apple seeds. In FIG. 5c, nasturtium seeds 62 are illustrated, which are comparable in size to small grapefruit pits. Marigolds seeds 64, illustrated in FIG. 5d, are small, straight and narrow. In FIG. 5e, zinnia seeds 66 are shown, which have a silhouette somewhat similar to that of the nasturtium, but which are smaller. Various techniques are employed to accommodate different types of seeds.

FIG. 6 is an illustration of an alternative form of a reticulate layer 10. The reticulate layer 10 comprises a grid 70 defined by transverse members 72 and longitudinal members 74. The terms transverse and longitudinal are arbitrary. They are used here to denote that the transverse members 72 and longitudinal members 74 cross each other. Apertures 76 are defined by portions of adjacent transverse members 72 that are between portions of the adjacent longitudinal members 74. The transverse and longitudinal members 72 and 74 need not necessarily be perpendicular to each other. It is preferred, in one form, to have transverse and longitudinal members 72 and 74 that are substantially perpendicular in order to maximize area of the apertures 76 for given lateral dimensions at the perimeter of each aperture 76.

The grid 70 may be made in many different ways. In one form, the grid 70 comprises molded, biodegradable thermoplastic. Fiber projections 78 are provided which extend from transverse and longitudinal members 72 and 74. The fiber projections 78 may be molded into the grid 70. Alternatively, fiber projections 78 may be adhered to the grid 70.

FIG. 7, consisting of FIGS. 7a and 7b, is a perspective view illustrating a first step in one method of forming an embodiment of FIG. 1. In the illustration of FIG. 7a, adhesive 80 is sprayed on the grid 40 from a sprayer 82. The same steps may be used in conjunction with other forms of the reticulate layer 10 as well. In an alternative embodiment, as in FIG. 7b, the adhesive 80 may be applied to the grid 40 by an applicator 84, which could be a roller or a brush. In yet another embodiment, a form of adhesive 80 may be used in which the grid 40 is dipped. Other forms of application may be utilized. The adhesive 80 is allowed to dry. In one preferred form, the adhesive 80 dries to a tacky state. In other embodiments, the adhesive 80 could dry and be rendered tacky by heating. Once the adhesive 80 is applied to the grid 40, seeds may be placed thereon.

One form of placement of seeds on the grid 40 is illustrated in FIG. 8, which is a perspective view. A template 90 may be utilized to place seeds 18 onto selected areas of the grid 40. Various ones of the seeds 58-66 (FIG. 5) may be placed in selected areas of the template 90. For example, a first region 92 may accommodate seeds 58. A second region 94 may accommodate seeds 60. A third region 96 may accommodate seeds 62. Other regions may be provided for other ones of the seeds 18. In this manner, a preselected pattern 90 of seeds is provided on the grid 40. Consequently, a preselected arrangement of flowers will be provided once the seed mat 1 is planted. Alternatively, the seeds 18 may be scattered onto the grid 40.

FIG. 9 is a perspective view of the hygroscopic layer 12 being assembled to the reticulate layer 10. Once the growth mixture 16 is placed on the reticulate layer 10, the hygroscopic layer 12 is assembled thereto. In the embodiment illustrated in FIG. 9, the hygroscopic layer 12 is rolled onto the reticulate layer 10. The growth mixture 16 is sandwiched between the hygroscopic layer 12 and the reticulate layer 10. The hygroscopic layer 12 may be adhered to the same adhesive 80 (FIG. 7) which holds the growth mixture 16. Alternatively, additional adhesive 80 may be utilized to fasten a hygroscopic layer 12 to the reticulate layer 10.

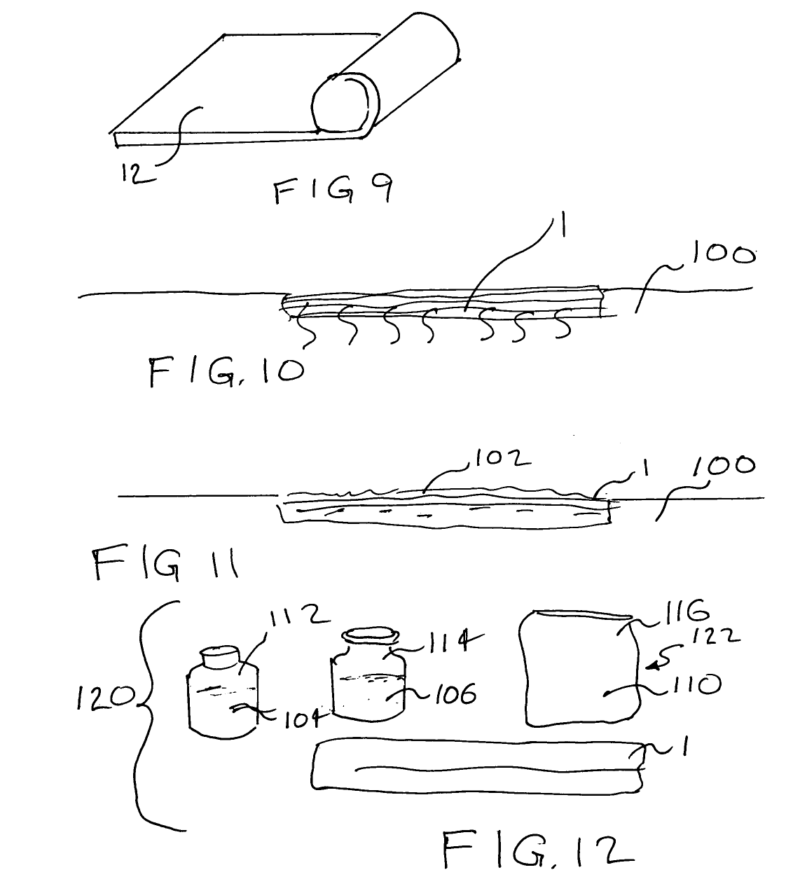

FIG. 10 is a cross-sectional view of a first stage installation of a seed mat in soil. In one preferred form, the seed mat 10 is planted in soil 100. In a nominal planting operation, the soil 100 is tilled to a depth of 4 inches, and an amendment, such as topsoil with compost, is tilled into the soil to the 4 -inch depth. The seed mat 1 is placed thereon.

As seen in FIG. 11, the seed mat 1 is then covered with a top layer 102. In an illustrative case, a top layer 102 having a thickness of ¼ inch is dispersed over the reticulate layer 10. The top layer may comprise soil. One or more soil amendments are preferably used. In a further embodiment, the top layer 102 comprises a “planting combination,” which comprises at least a soil amendment and a planting composition.

FIG. 12 is an illustration of a planting system 120 comprising the seed mat 1. The seed mat 1 is shown in a folded state. In one illustrative example, first and second soil amendments 104 and 106 are provided along with a planting composition 110. Other numbers of soil amendments could be provided. The soil amendments taken together form a soil amendment system 108. These components may be used to constitute the top layer 102 (FIG. 11). The first soil amendment 104 may comprise a hydrating medium. The second soil amendment 106 may comprise fertilizer. The planting composition 110 may comprise topsoil, potting soil or other planting composition. A system of soil amendments may be provided including selected components proportioned to the sizes and types of seeds in the seed mat.

In the embodiment of FIG. 12, the soil amendment system 108 may be used in addition to soil amendment components 20 (FIGS. 1 and 2). In one form, the soil amendment components 20 comprise soil amendments tailored to the particular seeds included in the seed mat 1. The soil amendment system 108 may comprise components to customize the planting system to a particular region or for a particular type of soil. Factors to consider in selecting a soil amendment include: soil texture; soil salinity and plant sensitivities to salts; salt content and pH of the amendment; and the desired length of time for the amendment to last in the soil. In the presented description, the characteristics of the amendments are referred to as preselected growing parameters

In sandy soil, sphagnum peat is a desirable amendment. Sandy soils will retain more water after sphagnum peat application. In some geographical regions, high salt content and high pH are common problems. In such areas the soil amendment system 108 should comprise components which are in low salts and which have an acidic pH.

The soil amendments, in the present illustration the soil amendment system 108 and the planting composition 110 comprise a planting combination 122. The soil amendments 104 and 106 and the planting composition 110 are respectively included in first, second, and third containers 112, 114, and 116. The containers 112, 114, and 116 have volumes proportioned to the size of the seed mat 1. In this manner, a gardener may install the seed mat 1 without the need for selecting a planting composition or soil amendments to be used. A gardener need neither measure nor calculate amounts of materials to be used. Consequently, an amateur gardener is enabled to plant a garden with a minimum of effort and uncertainty as to success.

Different models of seed mat 1 could be provided. For example, one form of seed mat 1 could comprise an herb garden. Another form could include seeds of plants used to attract butterflies. Other forms could be provided.

The previous description of some aspects is provided to enable any person skilled in the art to make or use the present invention. Various modifications to these aspects will be readily apparent to those skilled in the art, and the generic principles defined herein may be applied to other aspects without departing from the spirit or scope of the invention. For example, one or more elements can be rearranged and/or combined, or additional elements may be added. Thus, the present invention is not intended to be limited to the aspects shown herein but is to be accorded the widest scope consistent with the principles and novel features disclosed herein.

What is claimed is:

1. A seed mat comprising:
a reticulate layer comprising apertures defined by cross members, said reticulate layer comprising fibers extending into respective apertures;
a growth mixture layer secured to a first side of said reticulate layer; and
a hygroscopic, biodegradable cover layer secured to said first side of reticulate layer.

2. A seed mat according to claim 1, wherein said growth mixture comprises seeds and soil amendment components.

3. A seed mat according to claim 2, comprising an adhesive securing said growth mixture and said hygroscopic, biodegradable cover layer to said first side of reticulate layer.

4. A seed mat according to claim 3, wherein said reticulate layer comprises natural fiber.

5. A seed mat according to claim 3, wherein said reticulate layer comprises molded, biodegradable thermoplastic.

6. A seed mat according to claim 2, wherein said soil amendment components comprise components selected in correspondence with the type of said seeds.

7. A seed mat according to claim 6, wherein soil amendment components comprise pellets.

8. A seed mat according to claim 3, wherein said seed mat is divided into a plurality of zones, each said zone comprising a selected growth mixture.

9. A seed mat comprising:
a reticulate layer comprising apertures defined by cross members;
a growth mixture layer comprising seeds and soil amendment components secured to a first side of said reticulate layer;
an adhesive securing said growth mixture and said hygroscopic, biodegradable cover layer to said first side of reticulate layer; and
a hygroscopic, biodegradable cover layer secured to said first side of reticulate layer.

10. A seed mat according to claim 9, wherein said reticulate layer comprises natural fiber.

11. A seed mat according to claim 9, wherein said reticulate layer comprises molded, biodegradable thermoplastic.

12. A seed mat according to claim 9, wherein said soil amendment components comprise components selected in correspondence with the type of said seeds.

13. A seed mat according to claim 12, wherein soil amendment components comprise pellets.

14. A seed mat according to claim 9, wherein said seed mat is divided into a plurality of zones, each said zone comprising a selected growth mixture.

15. A seed system comprising a seed mat and further comprising premeasured amounts of soil amendments and planting composition proportioned to the size and seed composition of said seed mat, said seed mat comprising:
a reticulate layer comprising apertures defined by cross members;
a growth mixture layer comprising seeds and soil amendment components secured to a first side of said reticulate layer;
an adhesive securing said growth mixture and said hygroscopic, biodegradable cover layer to said first side of reticulate layer; and
a hygroscopic, biodegradable cover layer secured to said first side of reticulate layer.

16. A seed system comprising a seed mat according to claim 15, wherein said premeasured amounts of soil amendments are selected in correspondence with local soil conditions.

17. A seed system comprising a seed mat according to claim 15, wherein said premeasured amounts of soil amendments are selected to provide preselected growing parameters.
